(19) United States
(12) Patent Application Publication
(10) Pub. No.: US 2005/0027073 A1
(43) Pub. Date: Feb. 3, 2005

(54) Organometallic polymeric photonic bandgap materials

(75) Inventors: Yih-Hsing Lo, Yilan City (TW); Ming-Siao Hsiao, Taipei City (TW); Yi-Chun Chen, Hsinchu City (TW); Fong-Yee Hsu, Taoyuan County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/670,500

(22) Filed: Sep. 26, 2003

(30) Foreign Application Priority Data
Aug. 1, 2003 (TW) 092121121

(51) Int. Cl. C08L 9/00

(52) U.S. Cl. 525/98

(57) ABSTRACT

This invention relates to an organometallic polymeric photonic bandgap (OMPBG) material that can be defined by blending block copolymer (BCP) and at least two homopolymers, thereby obtaining an organometallic polymeric photonic bandgap hybrid material with periodic structure by self-assembly, wherein said homopolymers include at least one organometallic homopolymer. The improved material has high reflectivity.

### BACKGROUND OF THE INVENTION

(A) Field of the Invention

This invention relates to an organometallic polymeric photonic bandgap material that can be defined by blending diblock copolymer and at least one organometallic homopolymer.

(B) Description of Related Art

Polymeric photonic bandgap material is a structure formed by the periodic arrangements of materials with different dielectric constants, and provided with a lattice parameter same as its electromagnetic wavelength. Instead of altering the chemical structure of the material, the behavior of electromagnetic waves inside PBG, identical to that of electrons inside crystals, is controlled by the dielectric constant ratio, arrangement period, and space structure of PBG components, wherein the one-dimensional structure is widely used. For example, Optical mutilays structure, an one-dimensional PBG material obtained by periodically arranging multilayer dielectric materials, is widely employed as optical lens for its ability to prevent penetration of electromagnetic waves at certain frequencies, thereby achieving effective reflection.

Polymer chains of diblock copolymer (BCP) are connected with covalent bonds. Incompatible condition would occur between two polymer chains if they repel each other, thereby, same as surfactant, BCP is considered as an amphiphile material. It is based on the incompatible characteristic that the identical moleculars inside BCP would assemble themselves, resulting in phase separation. The separation distant, referred to as microphase separation, is limited by the R_{g} scale of the polymer chain to be around tens or hundreds of nanometer due to covalent bonds.

The morphology of microphase separation varies with the volume percentage of the two polymer chains inside copolymer. Over the years, a complete theory and research regarding the transformation of microphase separation morphology inside BCP self-assembly have been developed. The common microphase separation morphology include body-centered cubic packed spheres, hexagonally packed cylinder, ordered bicontinuous double diamond (OBDD, or gyroid), and lamellae. Besides varying the relative length of polymer chains via changing the degree of polymerization (equivalent to varying the volume percentage f_{A}), the morphology of copolymers can also be affected by temperature. The segment-segment interaction parameter (χ, χ=α+β/T) between two polymer chains varies with temperature, thus resulting in the reorganization of polymer chains. The percentage of the presence of each morphology can be indicated by a phase diagram with χ N vs. f_{A}, which is also employed to predict the morphology of BCP that will be controlled afterwards.

Besides varying chain length and temperature, the morphology can also be controlled by blending block copolymer with other homopolymers. For example, the blending method of copolymer A-b-B includes blending with homopolymer A (h-a), blending with homopolymers A and B, blending with homopolymer C (homopolymer C is compatible with monomer A and B), blending with another block copolymer such as A-b-C or C-b-D, etc. The microphase separation of blending system A-b-B/h-A is controlled by the ratio between the molecular weight of the homopolymer (M_{Ah}) and the corresponding block copolymer (M_{Ab}). Three domains can be defined. If M_{Ah}>M_{Ab} (M_{Ah}/M_{Ab}>1), h-A cannot dissolve into the microphase domain formed by polymer chain A. Instead, it is repelled outside A-b-B, thus creating the phenomenon of macrophase separation. If M_{Ah}≈MA_{b}(M_{Ah}/M_{Ab}>1, h-A will dissolve selectively into the microdomain formed by monomer A of the block copolymer. However, h-A will be located at the center of the microphase domain, referred to as dry-brush. If M_{Ah}<M_{Ab}(M_{Ah}/M_{Ab}<1), h-A tends to dissolve evenly into the microphase domain formed by polymer chain A of the block copolymer, referred to as wet-brush. The distance between the junction points of the block copolymers can be lengthened via dry-brush, which would cause morphology transformation afterwards.

With the popularization of fiber networks, the development of high quality optical and fiber devices is the focus point of today's world. E. L. Thomas et al., from the material department of MIT, suggested a new approach to eliminate the complicated procedures in the manufacturing process of photonic crystals (such as lithographic processing), minimize the volume of optical communication devices, and lower the production cost. The new approach, based on the self-assembly characteristic of diblock copolymers, is to produce a photonic crystal material with periodic structure and microphase separation within the range of visible light wavelength via blending process for bending and guiding light. This manufacturing process is simpler compare to lithographic processing since it only relies on the self-assembly characteristic of polymers. It is expected to have a large application potential in the optical communication industry due to its excellent economic benefits. It is true that the economic benefits of manufacturing a photonic crystal material with periodic structure and microphase separation within the range of visible light wavelength via blending process based on the self-assembly characteristic of diblock copolymers are good, but reflectivity will be lowered at the same time, thus photo-electric effect is negatively affected as a result.

Thomas at all announced another approach in 2001 and 2002 to improve the reflectivity of polymeric photonic bandgap crystal material with nano-metal. However, a portion of PS cannot be attracted by Au due to the reversible reactions between nano-metal (Au) and functionalized polystyrene (PS), thereby producing reflected waves of unblended PS—Au material (Ad. Mater, 2001.13.1783; Macromolecules, 2002.353.7561) besides the desired reflected waves in the reflection spectrum. As a result, the development of photonic bandgap materials with high reflectivity remains as a focus point of today.

Photonic bandgap crystals are widely used. They can be utilized to limit, control, and adjust the movement of three-dimensional photons, such as to prevent the conduction of photons at certain frequencies, designate the domain of photons within a confined frequency range at specific volumes, restrict self-illumination of illuminophores in excited state, and serve as lossless waveguides in specific directions. Four applications of PBGC are listed as follows:
(1) Waveguide Bends: With almost ten years of theory study and experiments, Villeneuve and Joannopoulos, physical scientists of MIT, with their partners in Sandia National Research Laboratories, have effectively bended light at a 90 degree angle inside PBGC material. Photons can move along the defects inside PBGC, therefore the desired light bending effect can be obtained by creating linear defects inside crystals to guide the movement of photons. Although the application of fiber has generated a communication revolution, the characteristic of light still limits the functions of optical devices, specifically complicated electrical circuits are still required at both ends to process signals, making the existing optical devices heavy, cumbersome, and low-efficient. This technique will serve as the foundation of future communication devices, micro-lasers, and integrated optical devices if the photonic crystal can be successfully structured and tested to bend waves in communication and optical devices at any angle. The theory has already been proved in experiments, but the manufacturing process of such device is not easy. In 1998, the work team produced the smallest three-dimensional PBGC in history; however, it is still too big to be utilized in communication application. In addition, they had successfully bended the 1.5 micrometer long communication microwave at a 90 degree angle. The proceeding topic would be how to produce a PBGC material that is approximately 100 micrometer long, and capable of bending light three-dimensionally.
(2) PBGC Fiber: We are now emphasizing on the role of PBGC fiber as optical communication channel in replace of traditional fibers. The waveguide functionality of traditional fibers is realized by the total reflection at the interface between high reflectivity (core) and low reflectivity (cladding). The transmit power and the information quantity of the incident light are limited by the energy tolerance and dispersion of the medium. Inside PBGC fiber, a new photonic energy gap is formed by the single-dimensional periodically arranged medium structure, where photonic waves with comparable wavelengths cannot transmit through such energy gap. If the material contains air, which has the lowest reflectivity, photons can still be restricted within the air channel since they cannot penetrate through and will be reflected back by the energy gap inside the air channel. PBGC material is considered as the best waveguide since the transmit power of the incident light is greatly improved, and problems of loss and dispersion are totally avoided due to the air medium.
(3) Resonant Chamber: Produce a point defect purposely for localizing and restricting light at the defecting point. The structure and symmetrical properties of the defecting points can be adjusted and designed according to your desired frequency.
(4) Filter: PBGC can be used to manufacture filtering devices since itself generates high reflectivity for electromagnetic waves with certain length and frequency.

In summary, photonic bandgap crystal material can be used in a wide range of industries, thereby the development of an improved photonic bandgap crystal material remains a meaningful research topic.

### SUMMARY OF THE INVENTION

According to the prior art of producing polymeric photonic material via blending process would result in lower reflectivity that causing the deficiency of photo-electric effect. The present invention provides a new organometallic polymeric photonic bandgap material with high reflectivity to rectify the imperfections of the prior art.

The primary objective of present invention is to provide an organometallic polymeric photonic bandgap material that can be defined by blending block copolymer and at least two homopolymers, thereby obtaining an organometallic polymeric photonic bandgap hybrid material with periodic structure by self-assembly, wherein said homopolymers comprise at least one functionalized organometallic homopolymer.

The structure of said block copolymer is represented by A-b-B (b means block), wherein A and B are polymer compounds, such as polystyrene (PS), polyisoprene (PI), or otheras like.

The periodic structure of said organometallic polymeric photonic bandgap material is arranged according to (AB)n, wherein A and B are defined as above, and n represents natural number.

The first structure of functionalized organometallic homopolymer A′ of the present invention is represented by A-C-D-E, wherein A is defined as above; C is C1˜20 alkylene (X), C1˜20 alkenylene (Y), C1˜20 alkynylene (Z), or C1˜20 arylene (W), wherein hydrogen on the W ring, if required, can be singly, dually, triply, or quadruply substituted by the substituent groups selected from X, Y, W and Z; D is O, N, Si, P, S or —CH₂; E is selected from the group consisting of titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), scandium (Sc), and compounds thereof.

The second structure of organometallic homopolymer A′ of the present invention is represented by A-C-E, wherein A, C, and E are defined as above.

The third structure of organometallic homopolymer A′ of the present invention is represented by A-D-E, wherein A, D, and E are defined as above.

The fourth structure of organometallic homopolymer A′ of the present invention is represented by A-E, wherein A and E are defined as above.

The above-mentioned four structures, wherein E is preferably selected from the group consisting of titanium (Ti), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), and compounds thereof. E is more preferably selected from the following group: titanium (Ti), chromium (Cr), molybdenum (Mo), tungsten (W), iron (Fe), ruthenium (Ru), osmium (Os), nickel (Ni), palladium (Pd), platinum (Pt), and compounds thereof.

The organometallic polymeric photonic bandgap material of the present invention, which can be defined by blending block copolymer (A-b-B) and homopolymers A′ and B, thereby obtaining an organometallic polymeric photonic bandgap hybrid material with periodic structure by self-assembly, wherein said homopolymer A′ is an organometallic homopolymer. The structures of said A, B, and A′ are defined as above.

The organometallic polymeric photonic bandgap material of the present invention can be utilized to form one-dimensional, two-dimensional, and three-dimensional structural systems, wherein the weigh ratio of A:B is 0.5:0.5 for one dimensional structure, 0.3:0.7 for two dimensional structure, and 0.35:0.65 for three dimensional structure.

The organometallic polymeric photonic bandgap material of the present invention, wherein the dimension of each domain is 15 to 5000 nm, the reflected wavelength is 50 to 5000 nm, thereby achieving reflectivity higher than 50%, wherein the best reflectivity is 96.3%.

Another objective of the present invention is to provide a manufacturing process for organometallic polymeric photonic bandgap material, comprising the following steps: synthesize organometallic homopolymer A′; dissolve and blend homopolymers A′ and B, and block copolymer (A-b-B) in an appropriate solvent; keep in room temperature for volatilizing the solvent; and place in oven for assuring all remained solvent has been removed to obtain the organometallic polymeric photonic bandgap material, wherein the structure of A, B and A′ are defined as above.

The above-mentioned solvent can be cumene, toluene, benzene, or other as like.

The first embodiment of the organometallic polymeric photonic bandgap material of the present invention is composed of PS-b-PI/Tp(PPh₃)[(PS)nPPh₂P]Ru═C═C(Ph)CHCN/PI, wherein the most preferable weight ratio is 98/1/1, and the reflectivity is 96%.

The second embodiment of the organometallic polymeric photonic bandgap material of the present invention is composed of PS-b-PI/(III)Ti—PSn/PI, wherein the most preferable weight ratio is 76/12/12, and the reflectivity is 59.44%.

The third embodiment of the organometallic polymeric photonic bandgap material of the present invention is composed of PS-b-PI/Tp(PPh₃) ₂NiBr—PS/PI, wherein the most preferable weight ratio is 76/12/12, and the reflectivity is 96.30%.

The organometallic polymeric photonic bandgap material of the present invention can be employed to manufacture various communication and photoelectric devices, as well as integrated photoelectricity, such as fiber, resonant chamber, filter, etc.

### BRIEF DESCRIPTION OF THE DRAWINGS

FIG. 1 is a proportional diagram, illustrating the relationship between reflected wavelength and PS, PI of films made by one-dimensional photonic bandgap material, which is produced by blending block copolymer PS-b-PI of high molecular weight with homogenous polymers of different weight ratios (PS and PI) at a certain composition proportion.

FIG. 2 is a comparative diagram, illustrating the reflectivity corresponding to different incident wavelengths for the organometallic polymeric photonic bandgap material of Embodiment 1 (PS-b-PI/Tp(PPh₃)[(PS)n PPh₂P]Ru—C═C(Ph)CHCN/PI, weight ratio: 98/1/1) and the photonic bandgap crystal of Comparative Embodiment (PS-b-PI/PS/PI, weight ratio: 100/0/0).

FIG. 3 is a diagram illustrating the reflectivity corresponding to different incident wavelengths for the organometallic polymeric photonic bandgap material of Embodiment 2 (PS-b-PI/(M)Ti—PSn/PI, Weight Ratio: 76/12/12).

FIG. 4 is a diagram illustrating the reflectivity corresponding to different incident wavelengths for the organometallic polymeric photonic bandgap material of Embodiment 3 (PS-b-PI/(PPh₃)₂NiBr—PS /PI, Weight Ratio: 76/12/12).

FIG. 5 is a TEM diagram for the organometallic polymeric photonic bandgap material of Embodiment 4 (PS-b-PI/(CO)₅W[(PS)nPPh₂P]/PI).

### DETAILED DESCRIPTION OF THE INVENTION

The following examples are used to further illustrate the advantages of the present invention. They are not listed to limit the claims of the present invention.

### EXAMPLE 1

Preparation of Functionalized Organometallic Homopolymer:

1. Synthesizing (PS)nPPh₂P (Mw<15000, P.D.I<1.3):

Dissolve styrene monomers into THF solution system; inject ^{s}BuLi at this time, stir for about 15 minutes to allow for reaction; overfeed with PPh₂PCl; stir for about 5 minutes; slowly pour the polymeric solution into methanol to obtain the polymeric precipitated (PS)nPPh₂P; filter; and suck with a vacuum system.

2. Synthesizing Tp(PPh₃)[(PS)n PPh₂P]Ru—C═C(Ph)CHCN:

Place Tp(PPh₃)₂Ru—C═C(Ph)CHCN and (PS)n PPh₂P (Mw<15000, P.D.I<1.3) in dichloromethane system; stir for about 15 to 60 minutes to allow for reaction; suck the system with vacuum system; extract with n-pentane and dry.

Manufacturing Process of Photonic Bandgap Material Sample—Bulk State Part:

1. Each component is dissolved into the solvent (cumene or toluene) separately according to their ratio (the weight ratio of PS-b-PI/Tp(PPh₃)[(PS)n PPh₂P]Ru—C═C(Ph)CHCN/PI is composed of 100/0/0, 98/1/1, 90/5/5, 80/10/10, 70/15/15, 60/20/20, 50/25/25, 40/30/30. etc.) under room temperature.

2. Pour the solution into the petri dish and cover it with a lid, such that the solution is completely surrounded by an environment of cumene or toluene; slowly volatilize the solution under low temperature and keep in room temperature for a week; place the solution inside an over with 35° C. for at least 24 hours to assure all remained solvent is removed. The desired sample is obtained at this point if the color of the sample surface is alternating from purple to blue, green, red, or etc.

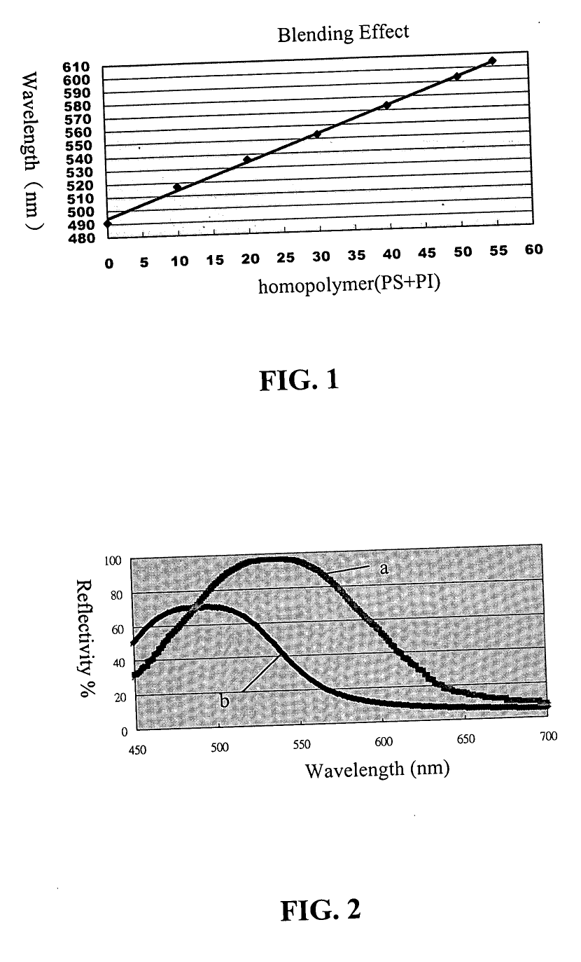

The one-dimensional photonic bandgap material films, which can be produced by blending block copolymer PS-b-PI of high molecular weight with homogenous polymers of different weight ratios (Tp(PPh₃)[(PS)n PPh₂P]Ru—C═C(Ph)CHCN and PI) at a certain composition proportion, are multicolor in appearance; specifically the color alternates from purple of pure block copolymer PS-b-PI to blue→green→orange red and other various colors with the increasing of the blending level. When observing the surface of the film with an optical microscope, the multicolored surface appears more bright and clear. One thing to take notice is that the surface of individual block copolymers and their corresponding homogeneous polymers appear to be white, however films produced by them are still multicolor in appearance. This phenomenon is consistent with the observation in the published thesis of Thomas and his research group, and illustrated that films made of one-dimensional photonic bandgap material can selectively reflect incident visible light wavelength. According to chromatology, the observed color phenomenon is caused by the specific wavelengths of the reflected light, which would slowly transfer from the ultraviolet into the infrared light region with the increasing of the blending level, as shown in FIG. 1. By simulating and deducing theories related to photonic bandgap crystal, it is proven that an one-dimensional photonic crystals with perfect structure (such as the structure of typical multiplayer films) demonstrate energy bands with special characters. The reflectivity of such one-dimentional photonic crystal films, which is produced by blending PS-b-PI/Tp(PPh₃)[(PS)n PPh₂P]Ru—C═C(Ph)CHCN/PI at a weight ratio composed of 100/0/0, 98/1/1, 70/15/15, 60/20/20, 50/25/25, 45/27.5/27.5, etc., is above 75%, wherein the 98/1/1 system produces the best reflectivity of 96%.

### COMPARATIVE EXAMPLE

When comparing the one-dimensional photonic bandgap material films made by only blending block copolymer PS-b-PI of high molecular weight with homogenous polymers of different weight ratios (PS and PI) at a certain composition proportion, according to the prior art (the thesis of Thomos and his research group), the observed color phenomenon is caused by the specific wavelengths of the reflected light. The relationship is shown is FIG. 1.

In addition, when investigating the relationship between reflectivity and the blending level of polymeric photonic bandgap crystal, a series of polymeric photonic bandgap crystals (Ps-b-PI/PS/PI) are prepared to detect the reflectivity under maximum wavelength. The result is shown in table 1:

TABLE 1

| | Composition (Weight | Maximum Incident | |
|---|---|---|---|
| | Ratio) | Wavelength | |
| Sample | (PS-b-PI/PS/PI) | λₘₐₓ, nm) | Reflectivity % |
| PBG | 100/0/0 | 491 | 71 |
| PBG-1 | 70/15/15 | 553 | 67 |
| PBG-2 | 60/20/20 | 573 | 63 |
| PBG-3 | 50/25/25 | 593 | 60 |
| PBG-4 | 45/27.5/27.5 | 604 | 55 |

According to the result, with the ratio change of PS-b-PI/PS/PI, maximum incident wavelength is increased, but reflectivity is decreased.

When comparing the organometallic polymeric photonic bandgap material involved in the production of Example 1 (PS-b-PI/Tp(PPh₃)[(PS)n PPh₂P]Ru—C═C(Ph)CHCN/PI, weight ratio: 98/1/1) with the photonic bandgap crystal of Comparative Example (PS-b-PI/PS/PI, weight ratio: 100/0/0), as shown in FIG. 2, PS-b-PI/Tp(PPh₃)[(PS)n PPh₂P]Ru—C═C(Ph)CHCN/PI (curve a)of the present invention is capable of achieving a reflectivity of 94%, while PS-b-PI/PS/PI (curve b) produced by prior art is only 71%.

### EXAMPLE 2

Preparation of Organometallic Homopolymer:

1. Synthesizing (III)Ti—PSn (Mw=9159, P.D.I=1.18):

Dissolve styrene monomers into cyclohexane solution system; inject ^{s}BuLi at this time, stir for about 30 minutes; place ClTi(OiPr)₃ in the system; stir the system over night; slowly pour the polymeric solution into methanol to obtain the polymerid precipitated (III)Ti—PSn filter; and suck with a vacuum system.

Manufacturing Process of Photonic Bandgap Material Sample—Bulk State Part:

1. Each component is dissolved into the solvent (cumene or toluene) separately according to their ratio (the weight ratio of PS-b-P[/(III)Ti—PSn/PI is composed of 100/0/0, 97/1.5/1.5, 80/10/10, 76/12/12, 70/15/15, 60/20/20, 50/25/25, 40/30/30. etc.) under room temperature.

2. Pour the solution into the petri dish and cover it with a lid, such that the solution is completely surrounded by an environment of cumene or toluene; slowly volatilize the solution under low temperature and keep in room temperature for a week; place the solution inside an over with 35° C. for at least 24 hours to assure all remained solvent is removed. The desired sample is obtained at this point if the color of the sample surface is alternating from purple to blue, green, red, or etc.

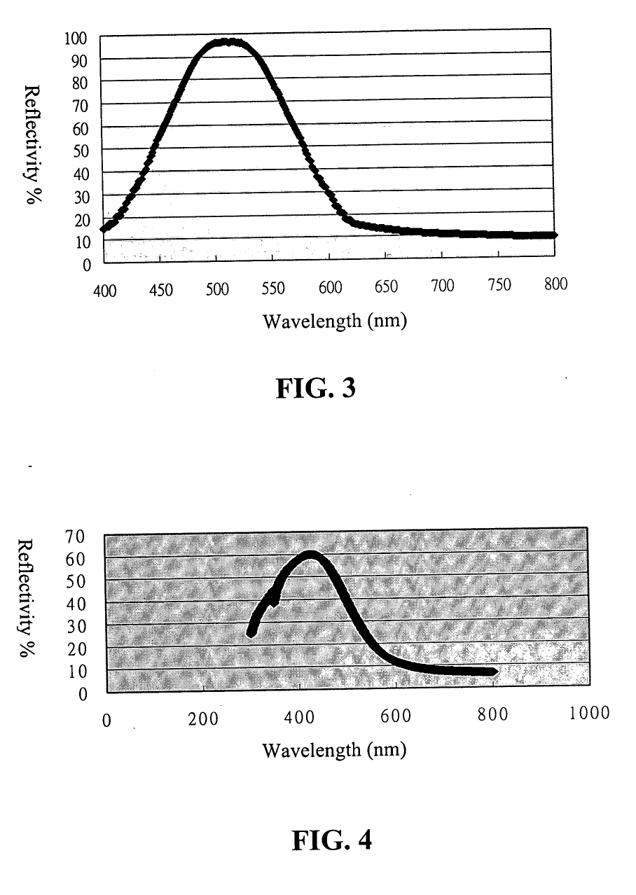

The one-dimensional photonic bandgap material films, which can be produced by blending block copolymer PS-b-PI of high molecular weight with homogenous polymers of different weight ratios ((III)Ti—PSn and PI) at a certain composition proportion, are multicolor in appearance; specifically the color alternates from purple of pure block copolymer PS-b-PI to blue→green→orange→red and other various colors with the increasing of the blending level. When observing the surface of the film with an optical microscope, the multicolored surface appears more bright and clear. By simulating and deducing theories related to photonic bandgap crystal, it is proven that an one-dimensional photonic crystals with perfect structure (such as the structure of typical multiplayer films) demonstrate energy bands with special characters. The weight ratio of such one-dimentional photonic crystal films are produced by blending PS-b-PI/(III)Ti—PSn /PI at a weight ratio composed of 100/0/0, 76/12/12, 70/15/15, 60/20/20, 50/25/25, 45/27.5/27.5, etc., wherein the 76/12/12 system has the best reflectivity of 96.30%, as shown in FIG. 3.

### EXAMPLE 3

Preparation of Organometallic Homopolymer:

1. Synthesizing(PPh₃)₂NiBr—PS (Mw=9592, P.D.I=1.86):

Dissolve styrene monomers into cyclohexane solution system; inject ^{s}BuLi at this time, stir for about 30 minutes; place (PPh₃)₂NiBr—PS in the system; stir the system over night;

slowly pour the polymeric solution into methanol to obtain the polymeric precipitated (PPh₃)₂NiBr—PS ; filter; and suck with a vacuum system.

Manufacturing Process of Photonic Bandgap Material Sample—Bulk State Part:

1. Each component is dissolved into the solvent (cumene or toluene) separately according to their ratio (the weight ratio of PS-b-PI/(PPh₃)₂NiBr—PS/PI is composed of 100/0/0, 97/1.5/1.5, 80/10/10, 76/12/12, 70/15/15, 60/20/20, 50/25/25, 40/30/30. etc.) under room temperature. 2. Pour the solution into the petri dish and cover it with a lid, such that the solution is completely surrounded by an environment of cumene or toluene; slowly volatilize the solution under low temperature, and keep in room temperature for a week; place the solution inside an over with 35° C. for at least 24 hours to assure all remained solvent is removed. The desired sample is obtained at this point if the color of the sample surface is alternating from purple to blue, green, red, or etc.

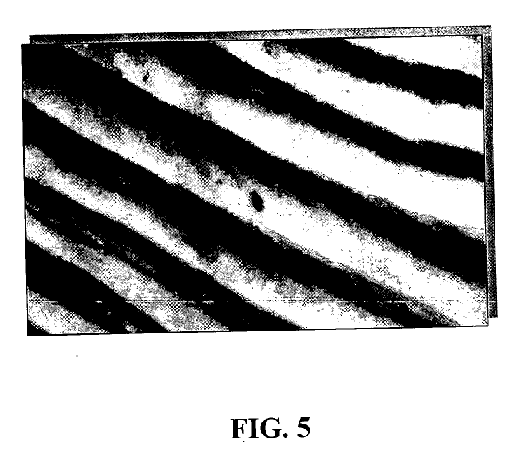

The one-dimensional photonic bandgap material films, which can be produced by blending block copolymer PS-b-PI of high molecular weight with homogenous polymers of different weight ratios ((PPh₃)₂NiBr—PS and PI) at a certain composition proportion, are multicolor in appearance; specifically the color alternates from purple of pure block copolymer PS-b-PI to blue→green→orange→red and other various colors with the increasing of the blending level. When observing the surface of the film with an optical microscope, the multicolored surface appears more bright and clear. By simulating and deducing theories related to photonic bandgap crystal, it is proven that perfectly structured one-dimensional photonic crystals (such as the structure of typical multiplayer films) demonstrate energy bands with special characters. The weight ratio of such one-dimensional photonic bandgap crystals films are produced by blending PS-b-PI/(PPh₃)₂NiBr−PS/PI at a weight ratio composed of 100/0/0, 76/12/12, 70/15/15, 60/20/20, 50/25/25, 45/27.5/27.5, etc., wherein the 76/12/12 system has the best reflectivity of 59.44%, as shown in FIG. 4.

### EXAMPLE 4

Preparation of Organometallic Homopolymer:

1. Synthesizing (PS)nLi (Mw<15000, P.D.I<1.3):

Dissolve styrene monomers into THF solution system; inject ^{s}BuLi at this time, and stir for about 15 minutes to allow for reaction.

2. Synthesizing (CO)₅W[(PS)nPPh₂P]:

Place THF solution containing (CO)₅W[(PS)nPPh₂P] and (PS)nLi (Mw<15000, P.D.I<1.3) in dichloromethane system; stir for about 15 to 16 minutes to allow for reaction; suck the system; extract with n-pentane and suck with a vacuum system.

Manufacturing Process of Photonic Bandgap Material Sample—Bulk State Part:

3. Each component is dissolved into the solvent (cumene or toluene) separately according to their ratio (the weight ratio of PS-b-PI/(CO)₅W[(PS)nPPh₂P]/PI is composed of 50/25/25, 33/34/33, 25/37.5/37.5, etc.) under room temperature.

4. Pour the solution into the petri dish and cover it with a lid, such that the solution is completely surrounded by an environment of cumene or toluene; slowly volatilize the solution under low temperature, and keep in room temperature for a week; place the solution inside an over with 35° C. for at least 24 hours to assure all remained solvent is removed. The desired sample is obtained at this point if the color of the sample surface is alternating from purple to blue, green, red, or etc.

The one-dimensional photonic bandgap material films can be produced by blending block copolymer PS-b-PI of high molecular mass with homogenous polymers of different weight ratios (CO)₅W[(PS)nPPh₂P] and PI) at a certain composition proportion, are multicolor in appearance; specifically the color alternates from purple of pure block copolymer PS-b-PI to blue→green→orange→red and other various colors with the increasing of the blending level. When observing the surface of the film with an optical microscope, the multicolored surface appears more bright and clear. By simulating and deducing theories related to photonic bandgap crystal, it is proven that an one-dimensional photonic crystals with perfect structure (such as the structure of typical multiplayer films) demonstrate energy bands with special characters. The reflectivity of such one-dimensional photonic bandgap crystal films, which is produced by blending PS-b-Pf/(CO)₅W[(PS)nPPh₂P]/PI at a weight ratio composed of 50/25/25, 34/33/33, 25/37.5/37.5, etc., is higher than 60%.

FIG. 5 illustrates the TEM diagram of the organometallic polymeric photonic bandgap material discussed in the present embodiment, wherein the black dotted part is organometallic compound (CO)₅W[(PS)nPPh₂P]; the gray part is PS phase; and the black part is PI phase. The purpose of the TEM diagram is to prove that organometallic compound (CO)₅W[(PS)nPPh₂P] can self-assemble in PS phase.

When comparing to the prior art, the organometallic polymeric photonic bandgap material produced by the present invention has a better reflectivity, and can be widely used as photonic crystal material for bending and guiding light. It is expected to have a large application potential in the optical communication industry due to its excellent economic benefits.

1. An organometallic polymeric photonic bandgap material that can be defined by blending block copolymer and at least two homopolymers, thereby obtaining an organometallic polymeric photonic bandgap hybrid material with periodic structure by self-assembly, wherein said homopolymers comprise at least one organometallic homopolymer.

2. The organometallic polymeric photonic bandgap material of claim 1, wherein the structure of said block copolymer is represented by A-b-B, wherein A and B are polymeric compounds.

3. The organometallic polymeric photonic bandgap material of claim 2, wherein said polymeric compounds are polystyrene (PS), polyisoprene (PI), or other as like.

4. The organometallic polymeric photonic bandgap material of claim 1, wherein said periodic structure is arranged according to (AB)n, wherein A and B are defined as above, and n represents natural number.

5. The organometallic polymeric photonic bandgap material of claim 1, wherein the structure of said organometallic homopolymer A′ is represented by A-C-D-E, wherein:
A is defined as above;
C is C1˜20alkylene (X), C1˜20 alkenylene (Y), C1I20 alkynylene (Z), or C6˜20 arylene (W), wherein hydrogen on the W ring atom, if required, can be singly, dually, triply, or quadruply substituted by the substituent groups selected from X, Y, W and Z;
D is O, N, Si, P, S or CH₂;
E is selected from the group consisting of titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), scandium (Sc), and compounds thereof:

6. The organometallic polymeric photonic bandgap material of claim 5, wherein said E is selected from the group consisting of titanium (Ti), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), and compounds thereof.

7. The organometallic polymeric photonic bandgap material of claim 6, wherein said E is selected from the group consisting of titanium (Ti), chromium (Cr), molybdenum (Mo), tungsten (W), iron (Fe), ruthenium (Ru), osmium (Os), nickel (Ni), palladium (Pd), platinum (Pt), and compounds thereof.

8. The organometallic polymeric photonic bandgap material of claim 1, wherein the structure of said organometallic homopolymer is represented by A-C-E, wherein A, C, and E are defined as above.

9. The organometallic polymeric photonic bandgap material of claim 1, wherein the structure of said organometallic homopolymer is represented by A-D-E, wherein A, D, and E are defined as above.

10. The organometallic polymeric photonic bandgap material of claim 1, wherein the structure of said organometallic homopolymer is represented by A-E, wherein A and E are defined as above.

11. An organometallic polymeric photonic bandgap material that can be defined by blending block copolymer (A-b-B) and homopolymers A′ and B, thereby obtaining an organometallic polymeric photonic bandgap hybrid material with periodic structure by self-assembly, wherein said homopolymer A′ is an organometallic homopolymer, the structure of A, B, and A′ are defined as above.

12. The organometallic polymeric photonic bandgap material of claim 11, which can be utilized to form an one-dimensional structural system, wherein the weigh ratio of A:B is 0.5:0.5 for said structural system.

13. The organometallic polymeric photonic bandgap material of claim 11, which can be utilized to form a two-dimensional structural system, wherein the weigh ratio of A:B is 0.3:0.7 for the structural system.

14. The organometallic polymeric photonic bandgap material of claim 11, which can be utilized to form a three-dimensional structural system, wherein the weigh ratio of A:B is 0.35:0.65 for said structural system.

15. The organometallic polymeric photonic bandgap material of claim 11, wherein the dimension of each domain is 15 to 5000 nm, the reflected wavelength is 50 to 5000 nm, and the reflectivity is higher than 50%.

16. The organometallic polymeric photonic bandgap material of claim 11, wherein said periodic structure is arranged according to (AB)n, wherein A and B are defined as above, and n represents natural number.

17. A manufacturing process of organometallic polymeric photonic bandgap material comprises the following steps:
Synthesizing organometallic homopolymer A′;
Dissolving and blend homopolymer A′, block copolymer (A-b-B), and homopolymer B in an appropriate solvent;
Keeping in room temperature for volatilizing the solvent; and
Placing in oven for assuring all remained solvent has been removed.

18. The manufacturing process of organometallic polymeric photonic bandgap material of claim 17, wherein said structure of A, B and A′ are defined as above.

19. The manufacturing process of organometallic polymeric photonic bandgap material of claim 17, wherein said solvent is cumene, toluene, benzene, or other as like.

20. The organometallic polymeric photonic bandgap material of claim 1 or 11, which is composed of PS-b-PI/Tp(PPh₃)[(PS)nPPh₂P]Ru—C═C(Ph)CHCN/PI.

21. The organometallic polymeric photonic bandgap material of claim 20, wherein the weight ratio of said PS-b-PI/Tp(PPh₃)[(PS)nPPh₂P]Ru—C═C(Ph)CHCN/PI is 98/1/1.

22. The organometallic polymeric photonic bandgap material of claim 1 or 11, which is composed of PS-b-PI/(III)Ti—PSn/PI.

23. The organometallic polymeric photonic bandgap material of claim 22, wherein the weight ratio of said PS-b-PI/(M)Ti—PSn/PI is 76/12/12.

24. The organometallic polymeric photonic bandgap material of claim 1 or 11, which is composed of PS-b-PI/Tp(PPh₃)₂NiBr—PS/PI.

25. The organometallic polymeric photonic bandgap material of claim 24, wherein the weight ratio of said PS-b-PI/Tp(PPh₃)₂NiBr—PS/PI is 76/12/12.

26. The organometallic polymeric photonic bandgap material of claim 1 or 11, which is composed of PS-b-PI/(CO)₅W[(PS)nPPh₂P]/PI.
